(19) United States
(12) Patent Application Publication
(10) Pub. No.: US 2023/0411029 A1
(43) Pub. Date: Dec. 21, 2023

(54) Metal Ion Separation Technique Using pH Adjustment And Resin Packed Columns

(71) Applicant: SHINE Technologies, LLC, Janesville, WI (US)

(72) Inventors: Marek Piechowicz, Beloit, WI (US); Abdul Momen, Janesville, WI (US); Mark Johnson, Janesville, WI (US); Riley McSweeny, Milton, WI (US); Eric Edwards, Janesville, WI (US)

(21) Appl. No.: 17/841,423

(22) Filed: Jun. 15, 2022

(51) Int. Cl. G21F 9/12; G21F 9/16; B01D 36/02; B01D 15/36

(52) U.S. Cl. CPC G21F 9/12; G21F 9/165; B01D 36/02; B01D 15/361

(57) ABSTRACT

A waste extraction system includes a precipitation tank comprising a waste stream input, a solution input, and a waste stream output, wherein the waste stream input is fluidly coupled to an upstream segment of a main waste pathway, a column effluent tank, an adsorption column positioned between and fluidly coupled to the precipitation tank and the column effluent tank along the main waste pathway, wherein the adsorption column houses an ion exchange resin and is positioned downstream the precipitation tank, a solution pathway extending from a solution source to the solution input of the precipitation tank, the solution source housing an alkaline solution, and a particle filtration unit positioned between and fluidly coupled to the precipitation tank and the adsorption column.

### STATEMENT REGARDING FEDERALLY SPONSORED RESEARCH AND DEVELOPMENT

The present disclosure was developed with Government support under Contract No. DE-NA0004010 awarded by the United States Department of Energy. The Government has certain rights in the present disclosure.

### TECHNOLOGY

The present disclosure relates generally to systems and methods for extracting waste radionuclides, for example, waste radionuclides generated in a medical isotope production process.

### BACKGROUND

Current techniques for nuclear waste separation include solvent-based extraction, often referred to as solvent extraction or liquid-liquid extraction. Solvent extraction is a separation technique in which an extractant containing organic phase is contacted with a metal-ion containing aqueous phase. Upon mixing, the metal ion is transferred from the aqueous phase into the organic phase. Despite industry reliance, solvent extraction exhibits many drawbacks including challenges associated with phase disengagement, formation of heavy or “third” phases, and the generation of large volumes of hazardous organic waste. Process reliance on hazardous aromatic organic solvents presents a particular challenge from an environmental stewardship standpoint. Many commercial waste haulers have low tolerance for the presence of benzene or other aromatic hydrocarbons in solidified waste.

Accordingly, a need exists for improved methods and systems for nuclear waste separation, for example, in a medical isotope production process.

### SUMMARY

According to a first aspect of the present disclosure, a waste extraction system includes a precipitation tank comprising a waste stream input, a solution input, and a waste stream output, wherein the waste stream input is fluidly coupled to an upstream segment of a main waste pathway, a column effluent tank, an adsorption column positioned between and fluidly coupled to the precipitation tank and the column effluent tank along the main waste pathway, wherein the adsorption column houses an ion exchange resin and is positioned downstream the precipitation tank, a solution pathway extending from a solution source to the solution input of the precipitation tank, the solution source housing an alkaline solution, and a particle filtration unit positioned between and fluidly coupled to the precipitation tank and the adsorption column.

A second aspect includes the waste extraction system of the first aspect, wherein the alkaline solution comprises a NaHCO₃ solution, a Na₂CO₃ solution, or a NaHCO₃/Na₂CO₃ solution.

A third aspect includes the waste extraction system of the first aspect or the second aspect, wherein the waste stream input and the solution input of the precipitation tank are each located at a first end of the precipitation tank and the waste stream output is located at a second end of the precipitation tank, opposite the first end.

A fourth aspect includes the waste extraction system of the third aspect, wherein the first end of the precipitation tank is above the second end of the precipitation tank.

A fifth aspect includes the waste extraction system of any of the previous aspects, wherein the adsorption column comprises a waste stream input located at a first end of the adsorption column and a waste stream output located at a second end of the adsorption column, the first end of the adsorption column is opposite the second end of the adsorption column, and the first end of the adsorption column is above the second end of the adsorption column.

A sixth aspect includes the waste extraction system of any of the previous aspects, wherein the ion exchange resin comprises ion exchange resin beads that comprise an average diameter in a range of from 400 μm to 800 μm.

A seventh aspect includes the waste extraction system of any of the previous aspects, wherein the ion exchange resin comprises a crystalline silicotitanate resin.

An eighth aspect includes the waste extraction system of any of the previous aspects, wherein the particle filtration unit comprises a plurality of filters, the plurality of filters comprise an initial filter and a final filter, the initial filter is upstream the final filter with respect to the waste stream output of the precipitation tank, and the initial filter comprises a larger mesh size than the final filter.

A ninth aspect includes the waste extraction system of the eighth aspect, wherein the plurality of filters comprise one or more intermediate filters positioned between the initial filter and the final filter, wherein the one or more intermediate filters each have a mesh size less than or equal to the mesh size of the initial filter and greater than or equal to the final filter.

According to a tenth aspect of the present disclosure, a method of radionuclide waste extraction includes directing a waste stream from an upstream segment of a main waste pathway into a precipitation tank, directing an alkaline solution into the precipitation tank, thereby raising the pH of the waste stream and inducing precipitation of a first target radionuclide from the waste stream, forming a radionuclide precipitate, directing the waste stream from the precipitation tank into an adsorption column, and adsorbing a second target radionuclide from the precipitation tank onto an ion exchange resin housed in the adsorption column.

An eleventh aspect includes the method of the tenth aspect, further comprising collecting the radionuclide precipitate using a particle filtration unit positioned between and fluidly coupled to the precipitation tank and the adsorption column.

A twelfth aspect includes the method of the tenth aspect of the eleventh aspect, wherein the first target radionuclide comprises strontium-90 and the second target radionuclide comprises cesium-137.

A thirteenth aspect includes the method of the tenth through twelfth aspects, wherein the waste stream in the upstream segment of the main waste pathway comprises a pH of from 0 to 3 and the waste stream entering the adsorption column comprises a pH of from 7 to 10.

A thirteenth aspect includes the method of the tenth through twelfth aspects, wherein the waste stream in the upstream segment of the main waste pathway comprises a pH of from 0 to 3 and the waste stream entering the adsorption column comprises a pH of from 7 to 10.

A fourteenth aspect includes the method of the tenth through thirteenth aspects, wherein the alkaline solution comprises a NaHCO₃ solution, a Na₂CO₃ solution, or a NaHCO₃/Na₂CO₃ solution.

A fifteenth aspect includes the method of the tenth through fourteenth aspects, further comprising directing the waste stream from the adsorption column to a column effluent tank, wherein the waste stream entering the column effluent tank comprises a treated waste comprising 0.04 curies per cubic meter or less of strontium-90 and 1 curie per cubic meter or less of cesium-137.

A sixteenth aspect includes the method of the fifteenth aspect, further comprising directing the treated waste from the column effluent tank into a waste tank and thereafter solidifying the treated waste.

A seventeenth aspect includes the method of the tenth through sixteenth aspects, wherein the waste stream in the upstream segment of the main waste pathway comprises a gram/liter level of uranium that is at least 500 times greater than a gram/liter level of both strontium-90 and cesium-137.

An eighteenth aspect includes the method of the tenth through seventeenth aspects, wherein the first target radionuclide comprises barium, cerium, cesium, lanthanum, molybdenum, sodium, neodymium, palladium, praseodymium, rubidium, rhodium, ruthenium, samarium, strontium, yttrium, zirconium, or protactinium, or a combination thereof and the second target radionuclide comprises barium, cerium, cesium, lanthanum, molybdenum, sodium, neodymium, palladium, praseodymium, rubidium, rhodium, ruthenium, samarium, strontium, yttrium, zirconium, or protactinium, or a combination thereof.

A nineteenth aspect includes the method of the tenth through eighteenth aspects, wherein the waste stream in the upstream segment of the main waste pathway comprises 1 gram/liter of uranium or greater.

A twentieth aspect includes the method of the tenth through nineteenth aspects, wherein the ion exchange resin comprises ion exchange resin beads that have an average diameter in a range of from 400 μm to 800 μm.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following detailed description of the illustrative embodiments can be understood when read in conjunction with the following drawings, where like structure is indicated with like reference numerals and in which:

FIG. 1 schematically depicts a waste extraction system, according to one or more embodiments shown and described herein;

FIG. 2 schematically depicts an example particle filtration unit of the waste extraction system of FIG. 1, according to one or more embodiments shown and described herein;

FIG. 3 schematically depicted another example particle filtration unit of the waste extraction system of FIG. 1, according to one or more embodiments shown and described herein; and

FIG. 4 schematically depicts ion exchange resin housed in an adsorption column of the waste extraction system of FIG. 1, according to one or more embodiments shown and described herein.

### DETAILED DESCRIPTION

Referring generally to the figures, embodiments of the present disclosure are directed to waste extraction systems and methods for removal of target waste radionuclides from a waste stream formed during a medical isotope production process. The waste stream includes multiple radionuclides, such as uranium (U-238), cesium-137 (Cs-137), and strontium-90 (Sr-90). The waste extraction system includes a precipitation tank, an adsorption column, and a column effluent tank fluidly coupled along a main waste pathway. The waste stream flows through the waste extraction system, which is configured to remove target radionuclides from the waste stream. The precipitation tank facilitates a pH adjustment step, and the adsorption column houses an ion exchange resin. The pH adjustment step uses an alkaline solution, such as a sodium bicarbonate solution, to increase the pH of the waste stream from a pH of about 1 to a pH of about 8. Increasing the pH of the waste stream precipitates a first target radionuclide, such as Sr-90, as well as other fission products from the waste stream, which are then filtered and removed. The resulting alkaline, uranium-containing effluent is directed from the precipitation tank to the adsorption column. The ion exchange resin housed in the adsorption column absorbs a second target radionuclide, such as Cs-137. For example, the ion exchange resin may exhibit a high affinity for Cs-137 over uranium under alkaline conditions.

The combination of precipitation and adsorption provided by the waste extraction system provides an efficient and effective system for removing certain radionuclides from a nuclear waste stream. Indeed, the waste extraction system does not introduce organic reagents or materials, precluding the generation of organic waste and simplifying waste disposal. Moreover, the waste extraction system does not precipitate from or otherwise concentrate uranium in solution, reducing criticality concerns, as uranium remains diluted in the waste stream. Embodiments of the waste extraction system and methods of radionuclide waste extraction using the waste extraction system will now be described and, whenever possible, the same reference numerals will be used throughout the drawings to refer to the same or like parts.

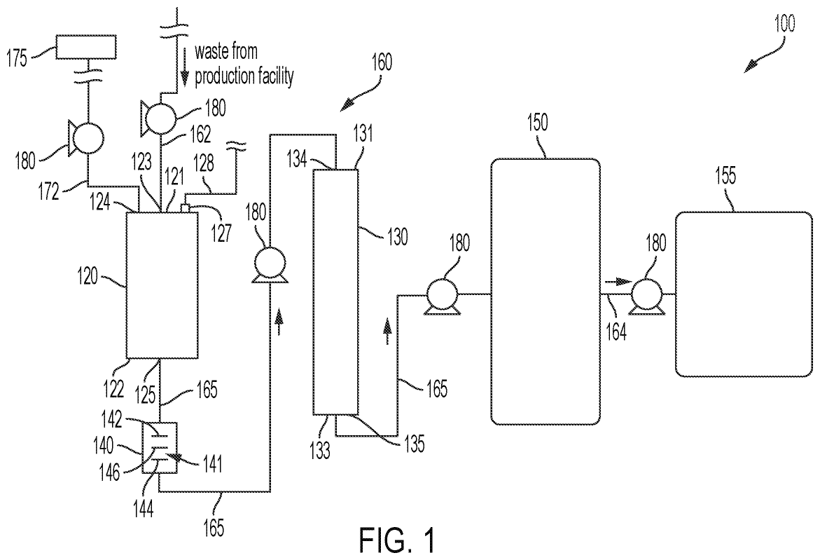

Referring now to FIG. 1, a waste extraction system 100 is shown, according to an illustrative embodiment. The waste extraction system 100 comprises a precipitation tank 120, a particle filtration unit 140, an adsorption column 130, a column effluent tank 150, and a waste tank 155, which are each fluidly coupled to a main waste pathway 160. The main waste pathway 160 comprises one or more pipes, tubes, or other fluid transport mechanisms for facilitating flow of a waste stream from a production facility, through the precipitation tank 120, the particle filtration unit 140, and the adsorption column 130, to the column effluent tank 150, and ultimately to the waste tank 155. One or more pumps 180 are coupled to the main waste pathway 160 to help generate fluid flow within the main waste pathway 160. In one example operation, an upstream segment 162 of the main waste pathway 160 fluidly couples the waste extraction system 100 with a production region of a medical isotope production facility and the waste stream comprises radionuclide waste generated by a medical isotope production process.

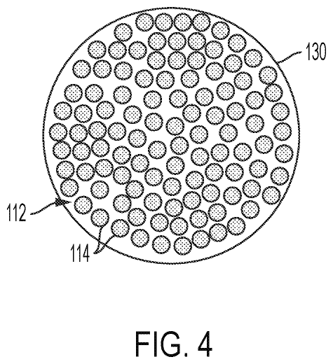

The precipitation tank 120, the particle filtration unit 140, and the adsorption column 130 are positioned between and fluidly coupled to the upstream segment 162 of the main waste pathway 160 and the column effluent tank 150. The precipitation tank 120 is upstream the adsorption column 130 such that a waste stream comprising radionuclide waste enters the waste extraction system 100 along the upstream segment 162 of the main waste pathway 160 (e.g., an initial waste stream), traverses the precipitation tank 120, which is fluidly coupled to the upstream segment 162, traverses the particle filtration unit 140, and thereafter traverses the adsorption column 130 along the main waste pathway 160. The precipitation tank 120 is fluidly coupled to a solution source 175 for introducing an alkaline solution into the precipitation tank 120 to raise the pH of the waste stream and precipitate a first target radionuclide, such as Sr-90, from the waste stream. The adsorption column 130 houses an ion exchange resin 112 (FIG. 4) configured to preferentially adsorb a second target radionuclide, such as Cs-137, from the raised pH waste stream. The column effluent tank 150 is fluidly coupled to the adsorption column 130 and, in operation, receives the now treated waste stream, which comprises reduced levels of the first target radionuclide and the second target radionuclide and may comprise reduced levels of additional radionuclides.

Referring still to FIG. 1, the precipitation tank 120 comprises a waste stream input 123, a solution input 124, and a gas outlet 127, each located at a first end 121 of the precipitation tank 120 and a waste stream output 125 located at a second end 122 of the precipitation tank 120. The waste stream input 123 is fluidly coupled to the upstream segment 162 of the main waste pathway 160 and the waste stream output 125 is fluidly coupled to an inter-column segment 165 of the main waste pathway 160 that extends from the precipitation tank 120 to the particle filtration unit 140 (which itself is fluidly coupled to the adsorption column 130 by another inter-column segment 165). The solution input 124 is fluidly coupled to a solution pathway 172 extending from the solution source 175 to the solution input 124. The gas outlet 127 is fluidly coupled to an off-gas pathway 128, which provides a pathway for off-gases formed in the precipitation tank 120 to exit the precipitation tank 120 and flow to an off-gas management system. As an example, in operation, sodium bicarbonate solution may contact sulfuric acid in the precipitation tank 120, producing carbon dioxide gas, which is vented through the gas outlet 127.

In operation, an alkaline solution, such as a NaHCO₃ solution, a Na₂CO₃ solution, or an NaHCO₃/Na₂CO₃ solution, may be directed into the precipitation tank 120 through the solution input 124. The alkaline solution raises the pH of the waste stream in the precipitation tank 120 inducing precipitation of the first target radionuclide, such as Sr-90 thereby forming a radionuclide precipitate. Forming the radionuclide precipitate removes an amount of the first target radionuclide from the waste stream. For example, the alkaline solution induces precipitation of 85% or more of the first target radionuclide initially present in the waste stream (e.g., present in the waste stream in the upstream segment 162 of the main waste pathway 160), for example, 85% or more of the first target radionuclide present in the waste stream, such as 86% or more, 87% or more, 88% or more, 89% or more, 90% or more, 91% or more, 92% or more, 93% or more, 94% or more, 95% or more, 96% or more, 97% or more, 98% or more, 98.5% or more, 99% or more, 99.5% or more, 99.9% or more, or a value in a range having any two of these numbers as endpoints.

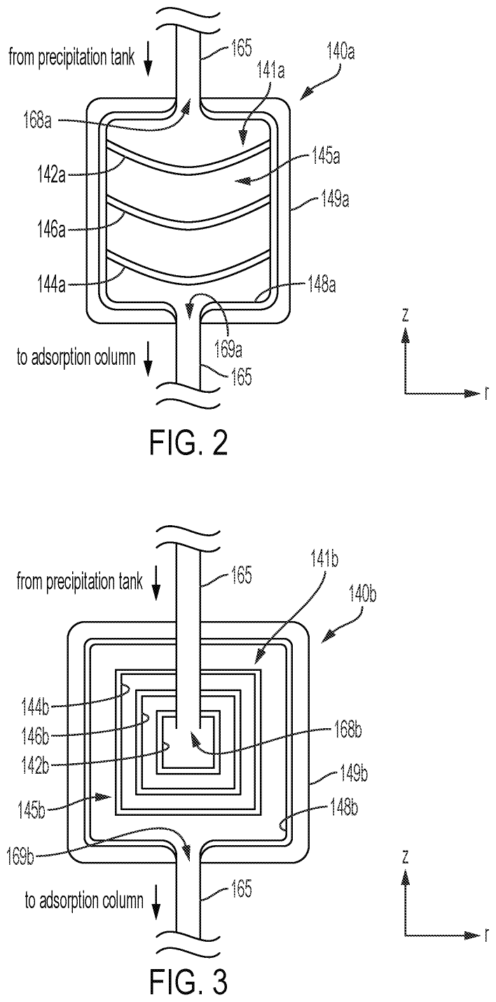

Referring now to FIGS. 1-3, radionuclide precipitate may be collected by the particle filtration unit 140. Example particle filtration units 140a and 140b are depicted in FIGS. 2 and 3, respectively. The particle filtration unit 140, 140a, 140b comprises a plurality of filters 141, such as a plurality of inline filters 141a (FIG. 2) or a plurality of concentric filters 141b (FIG. 3), that are fluidly coupled to the waste stream output 125 of the precipitation tank 120, for example, by an inter-column segment 165 of the main waste pathway 160. Each particle filtration unit 140a, 140b comprises a filter cavity 145a, 145b, a fluid input 168a, 168b fluidly coupled to the precipitation tank 120, and a fluid output 169a, 169b fluidly coupled to the adsorption column 130. The plurality of filters 141a, 141b are housed in the filter cavity 145a, 145b. The plurality of filters 141 include an initial filter 142 and a final filter 144. The initial filter 142 is upstream the final filter 144 with respect to the waste stream output 125 of the precipitation tank 120. The initial filter 142 comprises a larger mesh size than the final filter 144. In some embodiments, the plurality of filters 141 include one or more intermediate filters 146 positioned between the initial filter 142 and the final filter 144. The one or more intermediate filters 146 each have a mesh size less than or equal to the mesh size of the initial filter 142 and greater than or equal to the final filter 144. Indeed, in some embodiments, the plurality of filters 141 include progressively finer mesh sizes from the initial filter 142 to the final filter 144. This facilitates separate collection of differing size radionuclide precipitate particles in each inline filter, increasing the collection efficiency.

In operation, the waste stream enters the particle filtration unit 140a, 140b through the fluid input 168a, 168b, traverses the plurality of filters 141a, 141b, and exits through the fluid output 169a, 169b. The particle filtration unit 140a, 140b may include a shielding shell 149a, 149b that comprises lead or another radioactive shielding material, and an inner liner 148a, 148b that separates the filter cavity 145a, 145b from the shielding shell 149a, 149b. In some embodiments, the particle filtration unit 140, 140a, 140b is removably coupled to the main waste pathway 160 (e.g., removably coupled to inter-column segments 165 of the main waste pathway 160). Thus, the particle filtration unit 140, 140a, 140b may be removed from the main waste pathway 160 for disposal of collected radionuclide precipitate(s) and reinstallation of the particle filtration unit 140, 140a, 140b or, alternatively, for removal and replacement (e.g., replacement with a new particle filtration unit 140, 140a, 140b).

Referring now to FIG. 2, the particle filtration unit 140a is a linear particle filtration unit in which the filters (i.e., the plurality of inline filters 141a) are arranged along a Z-axis between a fluid input 168a and a fluid output 169a. The plurality of inline filters 141a include an initial inline filter 142a and a final inline filter 144a. The initial inline filter 142a is upstream the final inline filter 144a with respect to the fluid input 168a. The initial inline filter 142a comprises a larger mesh size than the final inline filter 144a. In some embodiments, the plurality of inline filters 141a include one or more intermediate inline filters 146a positioned between the initial inline filter 142a and the final inline filter 144a. The one or more intermediate inline filters 146a each have a mesh size less than or equal to the mesh size of the initial inline filter 142a and greater than or equal to the final inline filter 144a. Indeed, in some embodiments, the plurality of inline filters 141a include progressively finer mesh sizes from the initial inline filter 142a to the final inline filter 144a. This facilitates separate collection of differing size radionuclide precipitate particles in each inline filter, increasing the collection efficiency.

Referring now to FIG. 3, the particle filtration unit 140b is a concentric particle filtration unit in which the filters (i.e., the plurality of concentric filters 141b) are arranged concentrically, where radially outward filters surround radially inward filters, and each of the plurality of concentric filters 141b is radially outward the fluid input 168b. The plurality of concentric filters 141b include an initial concentric filter 142b and a final concentric filter 144b. The initial concentric filter 142b is upstream the final concentric filter 144b with respect to the fluid input 168b the particle filtration unit 140b. Moreover, both the initial concentric filter 142b and the final concentric filter 144b are radially outward (e.g., along the r-axis) from the fluid input 168b such that fluid (e.g., the waste stream) that enters the particle filtration unit 140b through the fluid input 168b passes through the initial concentric filter 142b before passing through the final concentric filter 144b and ultimately exiting through the fluid output 169b. The initial concentric filter 142b comprises a larger mesh size than the final concentric filter 144b. In some embodiments, the plurality of concentric filters 141b include one or more intermediate concentric filters 146b radially positioned between the initial concentric filter 142b and the final concentric filter 144b. The one or more intermediate concentric filters 146b each have a mesh size less than or equal to the mesh size of the initial concentric filter 142b and greater than or equal to the final concentric filter 144b. Indeed, in some embodiments, the plurality of concentric filters 141b include progressively finer mesh sizes from the initial concentric filter 142b to the final concentric filter 144b. This facilitates separate collection of differing size radionuclide precipitate particles in each concentric filter, increasing the collection efficiency. The particle filtration units 140a, 140b are two example particle filtration units 140 that could be used in the waste extraction system 100, however, it should be understood that any particle filtration unit sized and configured to removed radionuclide precipitates in the waste extraction system 100 could be used.

Referring again to FIG. 1, in some embodiments, the first end 121 of the precipitation tank 120 is opposite the second end 122 of the precipitation tank 120 and the first end 121 of the precipitation tank 120 is above the second end 122 of the precipitation tank 120. This orientation facilitates gravity assisted flow of the waste stream through the precipitation tank 120. Gravity assisted flow may reduce the pumping pressure and pumping power needed to flow the waste stream through the precipitation tank 120. Moreover, by positioning the second end 122 below the first end 121, the waste stream output 125 is positioned below the first end 121 and may be positioned at the lowest point of the precipitation tank 120, causing gravity assisted settling of the radionuclide precipitate at the second end 122 of the precipitation tank 120 facilitating flow of the radionuclide precipitate through the waste stream output 125, such that it can be collected as the waste stream traverses the particle filtration unit 140.

The adsorption column 130 comprises a waste stream input 134 and a waste stream output 135. The waste stream input 134 is located at a first end 131 of the adsorption column 130 and the waste stream output 135 is located at a second end 133 of the adsorption column 130. The waste stream input 134 is fluidly coupled to the inter-column segment 165 of the main waste pathway 160 that extends from the precipitation tank 120. The waste stream output 135 is fluidly coupled to the inter-column segment 165 of the main waste pathway 160 that extends towards the column effluent tank 150, for example, directly to the column effluent tank 150 (as depicted in FIG. 1) or to one or more intervening components of the waste extraction system 100 that may be positioned between the adsorption column 130 and the column effluent tank 150 that provide additional processing of the waste stream. Moreover, in some embodiments, the first end 131 of the adsorption column 130 is opposite the second end 133, and the first end 131 of the adsorption column 130 is above the second end 133. This orientation facilitates gravity assisted flow of the waste stream through the adsorption column 130. Gravity assisted flow may reduce the pumping pressure and pumping power needed to flow the waste stream through the adsorption column 130. Gravity assisted flow may also maximize contact between the ion exchange resin 112 (FIG. 4) and the waste stream, maximizing adsorption of the second target radionuclide.

The column effluent tank 150 is fluidly coupled to the main waste pathway 160, for example, one of the inter-column segments 165 of the main waste pathway 160. After passing through the precipitation tank 120, the particle filtration unit 140, and the adsorption column 130, the treated waste stream enters in the column effluent tank 150. The waste tank 155 is fluidly coupled to the column effluent tank 150 by a waste tank segment 164 of the main waste pathway 160. Resultant waste in the column effluent tank 150 may be directed into the waste tank 155 along the waste tank segment 166 for final treatment and removal off-site. This final treatment may comprise solidifying the resultant waste with concrete, to form solidified, final waste, which may occur in the waste tank 155. In some embodiments, the column effluent tank 150 and the waste tank 155 are the same volume, for example, a volume in a range of from 25 gallons to 75 gallons, such as 30 gallons, 35 gallons, 40 gallons, 45 gallons, 50 gallons, 55 gallons, 60 gallons, 65 gallons, 70 gallons, or the like. In other embodiments, the column effluent tank 150 and the waste tank 155 are different volumes and may comprise volumes in a range of from 25 gallons to 75 gallons. In operation, treated waste in the column effluent tank 150 may be directed into the waste tank 155 along the waste tank segment 164 for final treatment and removal off-site. For example, the treated waste stream may be eventually disposed as a solid waste form. The waste tank 155 may be pre-filled with a solidification agent, such as concrete, to facilitate solidification of treated waste received from the column effluent tank. The waste tank 155 may also comprising a mixing system, which may include a motor and a mixing mechanism to combine the treated waste and the solidification, forming solidified concrete waste, which is easier to dispose of than liquid waste.

After passing through the precipitation tank 120 and the adsorption column 130, the treated waste contains reduced amounts of the first and second target radionuclides and may have reduced amounts of other radionuclides. By removing radionuclides, such as the first and second target radionuclides, using the waste extraction system 100, the resultant waste comprises lower levels of radioactivity than the initial waste stream. Indeed, the target radionuclides contribute a disproportionate amount of the total radioactivity in the initial waste stream. For example, Cs-137 is a gamma emitting nuclide and thus, it is desirable to minimize the amount of the Cs-137 in the resultant waste. Adsorbing the target radionuclides, such as Cs-137 and Sr-90, allows these target radionuclides to be disposed of separately from the resultant waste, for example in a minimized volume that is sealed in concrete.

Referring now to FIG. 4, a schematic, cross sectional view of the adsorption column 130 is depicted. The ion exchange resin 112 is housed in the adsorption column 130 and may comprise a cation exchange resin. One such example ion exchange resin 112 is an inorganic cation exchange resin, such as crystalline silicotitanate resin. Another example of an ion-exchange resin includes Spherical Resorcinol-formaldehyde resin (sRF) resin. Without intending to be limited by theory, crystalline silicotitanate resin is configured such that the sterics of metal ions (e.g., radionuclide ions present in the waste stream) affect the adsorption process. For example, upon contact between crystalline silicotitanate resin and a cesium ion, such as Cs-137, which has a relatively large radius and hydrated diameter, the geometry of the crystalline silicotitanate resin preferentially adsorbs cesium ions. Moreover, crystalline silicotitanate resin has a preference for adsorption of Cs-137 under alkaline conditions and thus crystalline silicotitanate resin as the ion exchange resin 112 is effective in the adsorption column 130. Without intending to be limited by theory, adsorption of Cs-137 onto crystalline silicotitanate resin proceeds by a two-step mechanism, particularly, Cs⁺ hydration and a change in the rigidity of the crystalline silicotitanate resin network act in cooperation to accommodate the Cs-137 ion. In some embodiments, the ion exchange resin 112 comprises an adsorption capacity of Cs-137 in a range of from 100 mg of Cs-137 per gram of the cation exchange resin 116 (i.e., 100 mg/g) to 200 mg/g, such as from 125 mg/g to 175 mg/g, for example, 105 mg/g, 110 mg/g, 115 mg/g, 120 mg/g, 125 mg/g, 130 mg/g, 135 mg/g, 140 mg/g, 145 mg/g, 150 mg/g, 153 mg/g, 155 mg/g, 157 mg/g, 160 mg/g, 165 mg/g, 170 mg/g, 175 mg/g, 180 mg/g, 185 mg/g, 190 mg/g, 195 mg/g, 200 mg/g, or any range having any two of these values as endpoints, or any value in a range having any two of these values as endpoints.

By using a cation exchange resin with a particular affinity for Cs-137 adsorption, such as crystalline silicotitanate resin, as the ion exchange resin 112, Cs-137 may be removed from the increased pH waste stream (i.e., the waste stream after traversing the precipitation tank 120 and the particle filtration unit 140) in the presence of large amounts of uranium. Indeed, the waste stream may comprise a gram/liter level of uranium that is at least 500 times greater than a gram/liter level of both strontium-90 and cesium-137, for example, at least 750 times greater, at least 1000 times greater, at least 1250 times greater, at least 1500 times greater, at least 2000 times greater, or a multiplier in a range having any two of these values as endpoints. In some embodiments, the initial waste stream may comprise a gram/liter level of uranium that is at least 500 times greater than a gram/liter level of any individual of the following radionuclides, barium, cerium, lanthanum, molybdenum, neodymium, palladium, praseodymium, rubidium, rhodium, ruthenium, samarium, yttrium, and zirconium, for example, at least 750 times greater, at least 1000 times greater, at least 1250 times greater, at least 1500 times greater, at least 2000 times greater, or a multiplier in a range having any two of these values as endpoints. Moreover, uranium may comprise from 40% to 60% of the total radionuclides in the initial waste stream by mass. In some embodiments, the initial waste stream comprises 1 gram/liter of uranium or greater, such as 1.5 gram/liter, 2 gram/liter or greater, 2.5 gram/liter or greater 3 gram/liter or greater, and values in a range having two of these values as endpoints. Other radionuclides that may be present in the waste stream and may be adsorbed by the ion exchange resin 112 comprise barium, cerium, cesium, lanthanum, molybdenum, sodium, neodymium, palladium, praseodymium, rubidium, rhodium, ruthenium, samarium, strontium, yttrium, zirconium, protactinium, or a combination thereof.

As depicted in FIG. 4, in some embodiments, the ion exchange resin 112 comprises a plurality of ion exchange resin beads 114, such as beads of crystalline silicotitanate resin. The ion exchange resin beads 114 comprise an average diameter in a range of from 200 μm to 1000 μm, for example, in a range of from 400 μm to 800 μm, such as 400 μm, 425 μm, 450 μm, 475 μm, 500 μm, 525 μm, 550 μm, 575 82 m, 600 μm, 625 μm, 650 μm, 675 μm, 700 μm, 725 μm, 750 μm, 775 μm, 800 μm or any range having any two of these values as endpoints. In some embodiments, the plurality of the ion exchange resin beads 114 are dry poured into the adsorption column 130. Once in the adsorption column 130, the ion exchange resin beads 114 may be pre-treated with an alkaline solution, such as aqueous sodium carbonate, and added to the adsorption column 130 as a resin slurry (e.g., a resin in alkaline solution). The pre-treatment solution comprises a pH that is similar to (e.g., within 1 pH unit of) the initial waste stream. For example, the pre-treatment solution may comprise sodium carbonate, which has a pH of 8. Pre-treating the ion exchange resin beads 114 improves the separation (i.e., adsorption) effectiveness and efficiency, particularly when the waste stream is first introduced to the adsorption column 130. Moreover, pre-treating the ion exchange resin beads 114 may be performed at a location away from the waste stream, such as a different location within the waste extraction system 100 or a different location within the medical isotope production facility. Thus, personnel performing this pre-treatment may be located away from the radionuclide containing waste stream.

Referring to FIGS. 1-4, a method of radionuclide waste extraction using the waste extraction system 100 will now be described. The method comprises directing a waste stream from the upstream segment 162 of the main waste pathway 160 into the precipitation tank 120 and directing an alkaline solution into the precipitation tank 120, for example, a sodium bicarbonate solution. Directing the alkaline solution into the precipitation tank 120 raises the pH of the waste stream. The waste stream in the upstream segment 162 of the main waste pathway 160 comprises a pH of from 0 to 3, for example, 0.2, 0.4, 0.5, 0.6, 0.8, 1, 1.2, 1.4, 1.5, 1.6, 1.8, 2, 2.2, 2.4, 2.5, 2.6, 2.8, 3, or a value in a range comprising any two of these values as endpoints. Directing the alkaline solution into the precipitation tank 120 may raise the pH of the waste stream such that the waste stream entering the adsorption column 130 comprises a pH of from 7 to 10, for example, 7.2, 7.4, 7.5, 7.6, 7.8, 8, 8.2, 8.4, 8.5, 8.6, 8.8, 9, 9.2, 9.4, 9.5, 9.6, 9.8, 10, or a value having a range comprising any two of these values as endpoints.

The alkaline solution may be directed from the solution source 175 along the solution pathway 172 and into the precipitation tank 120 through the solution input 124. One or more of the pumps 180 may be fluidly coupled to the solution pathway 172 to help facilitate flow of the alkaline solution in the solution pathway 172 and into the precipitation tank 120. Raising the pH of the waste stream induces precipitation of a first target radionuclide, such as Sr-90, from the waste stream, forming a radionuclide precipitate. In some embodiments, the first target radionuclide comprises Sr-90. However, it should be understood that additional radionuclides may be precipitated in the precipitation tank 120, for example, Ba, La, Ce, Nd, Pr, Rb, Sm, Y, and Zr, any one of which may be considered the “first target radionuclide” in the terminology used herein. Moreover, it should be understood that the precipitation process is not limited to precipitating one single radionuclide, but instead may precipitate any combination of these radionuclides during the same process step.

Next, the method comprises directing the waste stream and radionuclide precipitate(s) the from the precipitation tank 120 to the particle filtration unit 140, for example, along an inter-column segment 165. The waste stream traverses the particle filtration unit 140 which removes the radionuclide precipitate(s) from the waste stream. The waste stream then flows from the particle filtration unit 140 to the adsorption column 130, for example, along another inter-column segment 165. In operation, the waste stream enters the adsorption column 130 through the waste stream input 134, and the ion exchange resin 112 housed in the adsorption column 130 adsorbs a second target radionuclide, such as Cs-137, present in the waste stream. By raising the pH of the waste stream in the precipitation tank 120, the adsorption effectiveness of the ion exchange resin 112 increases, particularly when the ion exchange resin comprises crystalline silicotitanate resin. In operation, the ion exchange resin 112 housed in the adsorption column 130 adsorbs 85% or more of the second target radionuclide initially present in the waste stream (e.g., present in the waste stream in the upstream segment 162 of the main waste pathway 160), for example, 85% or more of the strontium-90 and cesium-137 present in the waste stream, such as 86% or more, 87% or more, 88% or more, 89% or more, 90% or more, 91% or more, 92% or more, 93% or more, 94% or more, 95% or more, 96% or more, 97% or more, 98% or more, 98.5% or more, 99% or more, 99.5% or more, 99.9% or more, or a value in a range having any two of these numbers as endpoints.

Next, the method comprises directing the waste stream from the adsorption column 130 to the column effluent tank 150, for example, along an inter-column segment 165 of the main waste pathway 160. In some embodiments, the method further comprises directing the resultant waste to the waste tank 155 along the waste tank segment for final treatment and removal off-site. As noted above, the final treatment of the resultant waste may be solidified with concrete, to form solidified, final waste. This densifies the resultant waste. The final waste comprises a lower level of curies per cubic meter than the resultant waste used to form the final waste. Moreover, the methods of radionuclide waste extraction using the waste extraction system 100 described herein, are effective at remove large portions of target radionuclides such that the final waste formed from the resultant waste retain low levels of radioactivity. For example, the resultant waste may comprise less than 0.25 curies per cubic meter of Sr-90, for example, less than 0.2 curies per cubic meter, less than 0.15 curies per cubic meter, less than 0.1 curies per cubic meter, less than 0.08 curies per cubic meter, less than 0.06 curies per cubic meter, less than 0.05 curies per cubic meter, less than 0.04 curies per cubic meter, less than 0.03 curies per cubic meter, less than 0.02 curies per cubic meter, less than 0.01 curies per cubic meter, or any value in a range having any two of these values as endpoints. The resultant waste may also comprise less than 10 curies per cubic meter of Cs-137, for example, less than 8 curies per cubic meter, less than 6 curies per cubic meter, less than 5 curies per cubic meter, less than 4 curies per cubic meter, less than 2 curies per cubic meter, less than 1 curie per cubic meter, less than 0.75 curies per cubic meter, less than 0.5 curies per cubic meter, less than 0.25 curies per cubic meter, less than 0.1 curies per cubic meter, or any value in a range having any two of these values as endpoints. In some embodiments, the resultant waste comprises less than 0.04 curies per cubic meter of Sr-90 and less than 1 curie per cubic meter of Cs-137. In some embodiments, the final, densified waste comprises less than 0.04 curies per cubic meter of Sr-90 and less than 1 curie per cubic meter of Cs-137.

Moreover, the above values of curies per cubic meter in the resultant waste may be achieved using the waste extraction system 100 described herein in embodiments in which the initial waste stream (that is, the waste stream traversing the upstream segment 162 of the main waste pathway 160) comprises greater than 150 curies per cubic meter of Sr-90, for example, greater than 200 curies per cubic meter, greater than 300 curies per cubic meter, greater than 300 curies per cubic meter, greater than 300 curies per cubic meter, greater than 500 curies per cubic meter, greater than 1000 curies per cubic meter, greater than 2500 curies per cubic meter, greater than 5000 curies per cubic meter, or any value in a range having any two of these values as endpoints, and comprises greater than 44 curies per cubic meter of Cs-137, for example, greater than 50 curies per cubic meter, greater than 100 curies per cubic meter, greater than 250 curies per cubic meter, greater than 500 curies per cubic meter, greater than 800 curies per cubic meter, greater than 1000 curies per cubic meter, greater than 1500 curies per cubic meter, greater than 2000 curies per cubic meter, greater than 3500 curies per cubic meter, or any value in a range having any two of these values as endpoints.

While Cs-137 and Sr-90 are referred to as the target radionuclides in the embodiments described herein, other target radionuclides may be present in the waste stream and precipitated by pH increase in the precipitation tank 120 and/or adsorbed by the ion exchange resin 112 housed in the adsorption column 130. For example, other target radionuclides that may be present in the waste stream and may be precipitated in the precipitation tank 120 and/or adsorbed by the ion exchange resin 112 comprise barium, cerium, cesium, lanthanum, molybdenum, sodium, neodymium, palladium, praseodymium, rubidium, rhodium, ruthenium, samarium, strontium, yttrium, zirconium, protactinium, or a combination thereof.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical values or idealized geometric forms provided. Accordingly, these terms should be interpreted as indicating that insubstantial or inconsequential modifications or alterations of the subject matter described and claimed are considered to be within the scope of the disclosure as recited in the appended claims.

The term “coupled” and variations thereof, as used herein, means the joining of two members directly or indirectly to one another. Such joining may be stationary (e.g., permanent or fixed) or moveable (e.g., removable or releasable). Such joining may be achieved with the two members coupled directly to each other, with the two members coupled to each other using a separate intervening member and any additional intermediate members coupled with one another, or with the two members coupled to each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, optical, or fluidic.

References herein to the positions of elements (e.g., “top,” “bottom,” “above,” “below”) are merely used to describe the orientation of various elements in the FIGURES. It should be noted that the orientation of various elements may differ according to other exemplary embodiments, and that such variations are intended to be encompassed by the present disclosure.

Although the figures and description may illustrate a specific order of method steps, the order of such steps may differ from what is depicted and described, unless specified differently above. Also, two or more steps may be performed concurrently or with partial concurrence, unless specified differently above. Such variation may depend, for example, on the software and hardware systems chosen and on designer choice. All such variations are within the scope of the disclosure. Likewise, software implementations of the described methods could be accomplished with standard programming techniques with rule-based logic and other logic to accomplish the various connection steps, processing steps, comparison steps, and decision steps.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized combination. It is therefore intended that the appended claims cover all such changes and modifications that are within the scope of the claimed subject matter.

What is claimed is:

1. A waste extraction system comprising:
a precipitation tank comprising a waste stream input, a solution input, and a waste stream output, wherein the waste stream input is fluidly coupled to an upstream segment of a main waste pathway;
a column effluent tank;
an adsorption column positioned between and fluidly coupled to the precipitation tank and the column effluent tank along the main waste pathway, wherein the adsorption column houses an ion exchange resin and is positioned downstream the precipitation tank;
a solution pathway extending from a solution source to the solution input of the precipitation tank, the solution source housing an alkaline solution; and
a particle filtration unit positioned between and fluidly coupled to the precipitation tank and the adsorption column.

2. The waste extraction system of claim 1, wherein the alkaline solution comprises a NaHCO₃ solution, a Na₂CO₃ solution, or a NaHCO₃/Na₂CO₃ solution.

3. The waste extraction system of claim 1, wherein the waste stream input and the solution input of the precipitation tank are each located at a first end of the precipitation tank and the waste stream output is located at a second end of the precipitation tank, opposite the first end.

4. The waste extraction system of claim 3, wherein the first end of the precipitation tank is above the second end of the precipitation tank.

5. The waste extraction system of claim 1, wherein:
the adsorption column comprises a waste stream input located at a first end of the adsorption column and a waste stream output located at a second end of the adsorption column;
the first end of the adsorption column is opposite the second end of the adsorption column; and
the first end of the adsorption column is above the second end of the adsorption column.

6. The waste extraction system of claim 1, wherein the ion exchange resin comprises ion exchange resin beads that comprise an average diameter in a range of from 400 μm to 800 μm.

7. The waste extraction system of claim 1, wherein the ion exchange resin comprises a crystalline silicotitanate resin.

8. The waste extraction system of claim 1, wherein:
the particle filtration unit comprises a plurality of filters;
the plurality of filters comprise an initial filter and a final filter;
the initial filter is upstream the final filter with respect to the waste stream output of the precipitation tank; and
the initial filter comprises a larger mesh size than the final filter.

9. The waste extraction system of claim 8, wherein the plurality of filters comprise one or more intermediate filters positioned between the initial filter and the final filter, wherein the one or more intermediate filters each have a mesh size less than or equal to the mesh size of the initial filter and greater than or equal to the final filter.

10. A method of radionuclide waste extraction, the method comprising:
directing a waste stream from an upstream segment of a main waste pathway into a precipitation tank;
directing an alkaline solution into the precipitation tank, thereby raising the pH of the waste stream and inducing precipitation of a first target radionuclide from the waste stream, forming a radionuclide precipitate;
directing the waste stream from the precipitation tank into an adsorption column; and
adsorbing a second target radionuclide from the precipitation tank onto an ion exchange resin housed in the adsorption column.

11. The method of claim 10, further comprising collecting the radionuclide precipitate using a particle filtration unit positioned between and fluidly coupled to the precipitation tank and the adsorption column.

12. The method of claim 10, wherein the first target radionuclide comprises strontium-90 and the second target radionuclide comprises cesium-137.

13. The method of claim 10, wherein the waste stream in the upstream segment of the main waste pathway comprises a pH of from 0 to 3 and the waste stream entering the adsorption column comprises a pH of from 7 to 10.

14. The method of claim 10, wherein the alkaline solution comprises a NaHCO₃ solution, a Na₂CO₃ solution, or a NaHCO₃/Na₂CO₃ solution.

15. The method of claim 10, further comprising directing the waste stream from the adsorption column to a column effluent tank, wherein the waste stream entering the column effluent tank comprises a treated waste comprising 0.04 curies per cubic meter or less of strontium-90 and 1 curie per cubic meter or less of cesium-137.

16. The method of claim 15, further comprising directing the treated waste from the column effluent tank into a waste tank and thereafter solidifying the treated waste.

17. The method of claim 10, wherein the waste stream in the upstream segment of the main waste pathway comprises a gram/liter level of uranium that is at least 500 times greater than a gram/liter level of both strontium-90 and cesium-137.

18. The method of claim 10, wherein:
the first target radionuclide comprises barium, cerium, cesium, lanthanum, molybdenum, sodium, neodymium, palladium, praseodymium, rubidium, rhodium, ruthenium, samarium, strontium, yttrium, zirconium, or protactinium, or a combination thereof; and
the second target radionuclide comprises barium, cerium, cesium, lanthanum, molybdenum, sodium, neodymium, palladium, praseodymium, rubidium, rhodium, ruthenium, samarium, strontium, yttrium, zirconium, or protactinium, or a combination thereof.

19. The method of claim 10, wherein the waste stream in the upstream segment of the main waste pathway comprises 1 gram/liter of uranium or greater.

20. The method of claim 10, wherein the ion exchange resin comprises ion exchange resin beads that have an average diameter in a range of from 400 μm to 800 μm.
